(19) United States
(12) Patent Application Publication
(10) Pub. No.: US 2008/0083553 A1
(43) Pub. Date: Apr. 10, 2008

(54) Current conductor

(76) Inventor: Markus Gaertner, Wuppertal (DE)

Correspondence Address: DELPHI TECHNOLOGIES, INC., M/C 480-410-202, PO BOX 5052, TROY, MI, 48007, US

(21) Appl. No.: 11/973,634

(22) Filed: Oct. 9, 2007

(30) Foreign Application Priority Data
Oct. 9, 2006 (EP) 06021148.9

(51) Int. Cl. H02G 3/04; H01R 43/00

(52) U.S. Cl. 174/68.3; 29/825

(57) ABSTRACT

The invention relates to a current conductor, in particular for motor vehicles, to which at least one electrically conductive connector element can be fastened to make an electrical contact, with the current conductor having a recess which includes a wall section which is pierced by at least one plug opening for the connector element.

### TECHNICAL FIELD

The present invention relates to a current conductor, in particular for motor vehicles, to which at least one electrically conductive connector element can be fastened to form an electrical contact.

### BACKGROUND OF THE INVENTION

Current conductors of this type are used, for example, in current distributor boxes in motor vehicles, in particular in fuse boxes. It is known to pierce current conductors of this type and to connect the connector elements to the current conductor by pressing a spigot formed at the connector element into the hole to establish an electrical contact between the current conductor and the connector element. The holding force of a connection of this type is, however, limited.

### SUMMARY OF THE INVENTION

It is the underlying object of the invention to set forth a current conductor of the initially named kind which ensures an increased holding force for a connector element.

This object is satisfied by a current conductor having the features of claim 1, and in particular in that the current conductor has a recess which includes a wall section which is pierced by at least one plug opening for the connector element.

In accordance with the invention, a plug opening, which is configured as a passage opening, is provided in the wall section of the recess and the connector element can be fastened to the current conductor via it. The recess made in accordance with the invention can ensure that the height of the recess and thus the effective height of the current conductor with respect to the fastening of the connector element is larger than the thickness of the current conductor so that an improved holding of the connector element at the current conductor can be achieved with respect to known current conductors which do not have the recess in accordance with the invention. Consequently, a larger contact surface can be provided for the fastening of the connector element by the current conductor in accordance with the invention than with a known current conductor.

The region of the wall section bounding the plug opening can act as a shoulder for the connector element, said shoulder at least impeding or largely preventing a releasing or breaking off of the connector element, in particular with forces which engage transversely to a press-in direction of the connector element. To the extent that the region of the wall section bounding the plug opening is also elastically deformed on the pressing in of a connector element, the region bounding the plug opening can exert a spring force on a connector element pressed into the plug opening.

The recess is manufactured, for example, by deep drawing. The plug opening in the wall section of the recess is manufactured, for example, by stamping out.

Advantageous embodiments of the invention are also recited in the dependent claims, in the description and in the drawing.

In accordance with an aspect of the invention, two plug openings each passing through the wall section are provided. It is hereby achieved that the connector element can be clamped in a multiple manner in the wall section of the recess, whereby the holding of the connector element is further improved.

The plug openings are preferably disposed opposite one another with respect to a center axis of the recess. This ensures that connector elements can be used which can be manufactured simply and favorably and/or are conventional, plate-like connector elements whose oppositely disposed narrow sides can engage into the plug openings oppositely disposed with respect to the center axis of the recess.

In accordance with another aspect of the invention, at least one adjacent opening is provided for the plug opening, for at least one plug opening or for each plug opening, said adjacent opening passing through the current conductor, with the adjacent opening being positioned such that a web portion arranged in the region of the wall section and/or acting as a bending beam is formed between the plug opening and the adjacent opening. In particular in this way, the web portion can also have elastic properties, for example, due to its dimensioning and/or material property so that—in the manner of a bending beam—a spring force can be exerted onto a connector element pressed into the plug opening. It can in particular be possible with a web portion made in a particularly elastic manner to release the connector element from the current conductor again with a corresponding exertion of force without any substantially permanent deformation and/or destruction of the current conductor.

The recess is preferably made in pot shape or in tub shape and/or symmetrical with respect to a central axis, in particular rotationally symmetrical. Recesses made in this manner can be manufactured particularly easily and/or with conventionally shaped tools, for example with conventionally shaped stamp-die apparatus. Generally, however, the recess can also be formed differently.

In accordance with another aspect of the invention, the recess includes a recess base which is pierced by a contact opening into which a spigot of the connector element can be plugged or pressed to form an electrical contact. It is hereby made possible to separate the two functions, namely the establishing of an electrical contact between the connector element and the current conductor as well as the fastening of the connector element to the current conductor. The wall section is then primarily responsible for the fastening of the connector element to the current conductor; the recess base is mainly responsible or the making of the electrical contact. As a rule, however, the wall region will continue to contribute to the making of an electrical contract and the recess bas will also continue to contribute to the fastening of the connector element. However, it can be achieved by the separation that the configuration of the wall section or the recess base can be optimized with respect to the respective main function.

The invention furthermore relates to an arrangement having at least one current conductor such as has been explained above to which at least one electrically conductive connector element has been fastened to make an electrical contact, said connector element including a contact section which is pressed into the at least one plug opening of the current conductor. The same advantages substantially result in this case as were explained above in connection with the current conductor. The contact section can be introduced into the plug opening and/or be guided at least partly through it.

The connector element preferably includes a spigot which is plugged or pressed into a contact opening of the current conductor piercing the recess base of the recess to form an electrical contact.

The invention further relates to a method for the manufacture of a current conductor, in particular for motor vehicles, to which at least one electrically conductive connector element can be fastened to form an electrical contact, with a region of the current conductor being selected for the fastening of the connector element, the region being worked, in particular by deep drawing, such that a recess is formed and a marginal section or wall section of the region being worked, in particular by stamping out, such that at least one plug opening is formed, with a contact section of the connector element being able to be pressed into the at least one plug opening.

In this process, the recess can be formed first and then the plug opening, or vice versa. To the extent that the plug opening is formed first and then the recess and that a distortion of the original geometry occurs in this connection, it is preferred for the contour formed by the plug opening to be reworked.

### BRIEF DESCRIPTION OF THE DRAWINGS

Non-restricting embodiments of the invention are shown in the drawing and will be described in the following. There are shown, schematically in each case:

FIGS. 1a, 1b are perspective views, partly in cross-section, of a current conductor in accordance with the invention;

FIGS. 2a, 2b are perspective views, partly in cross-section, of an arrangement in accordance with the invention with the current conductor of FIG. 1 and an electrically conductive connector element; and

FIG. 3 is a top view of a further aspect of a current conductor in accordance with the invention.

### DESCRIPTION OF THE PREFERRED EMBODIMENT

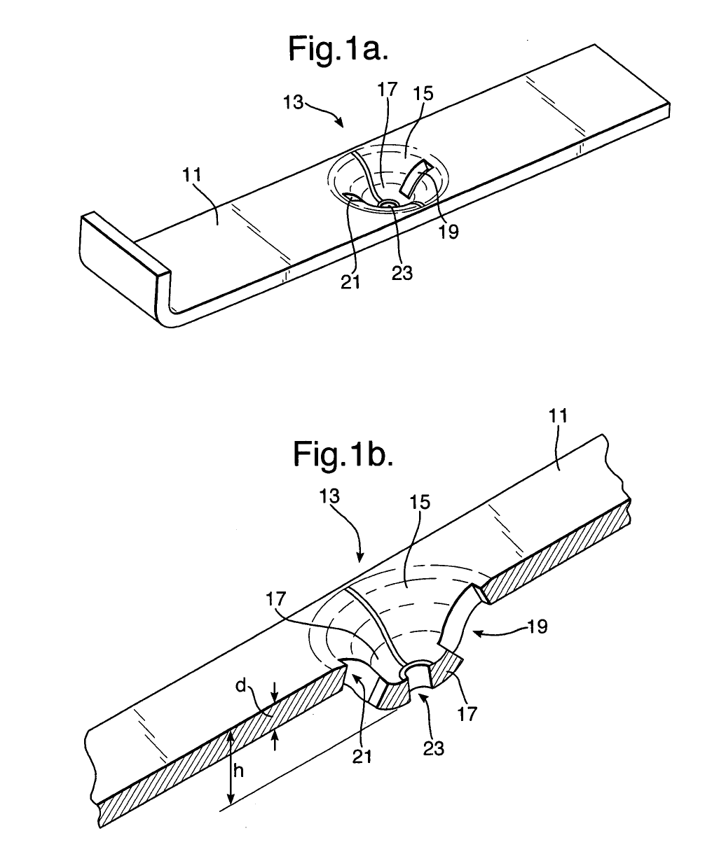

The electrically conductive current conductor 11 shown in a perspective view in FIG. 1a and in a sectioned view in FIG. 1b first has a pot-like recess 13 which is manufactured by deep drawing and which is made rotationally symmetrical around a center axis. The recess 13 includes a peripheral wall section 15 and a recess base 17.

The wall section 15 is pierced by two plug openings 19 and 21 which are oppositely disposed with respect to the center axis of the recess 13. The plug openings 19 and 21 manufactured by stamping out are each formed as an elongate hole and their longitudinal extents are each oriented parallel to the longitudinal direction of the current conductor 11. The recess base 17 is pierced by a circular contact opening 23 which was likewise manufactured by stamping out.

The current conductor 11 has a thickness d which amounts, for example, to 0.6 mm. In the region of the recess 13, the current conductor 11 has an effective or functional height h which corresponds to the total height of the recess 11 and is larger than the thickness d of the current conductor 11. The effective height h is that part of the total height of the current conductor 11 which contributes to the fastening of a connector element explained in the following to the current conductor 11.

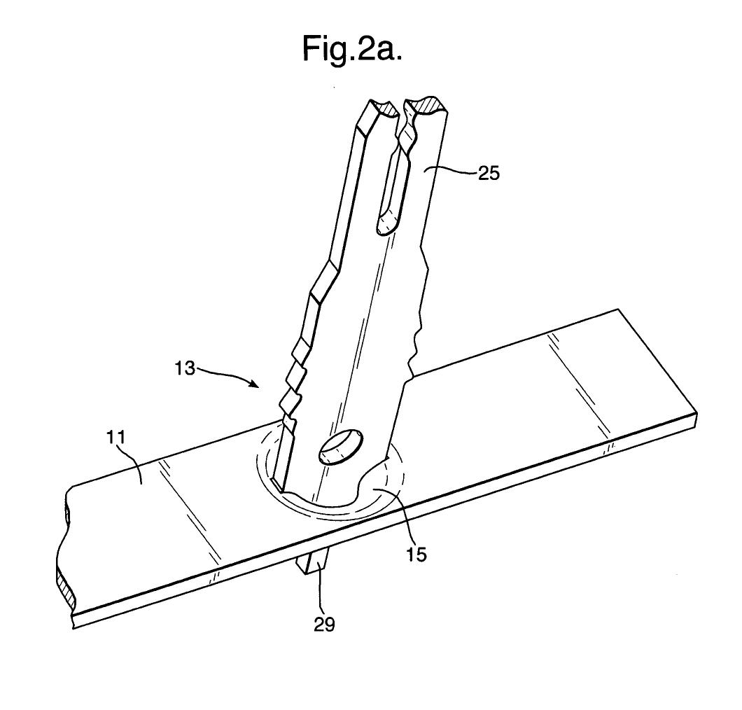

An electrically conductive connector element 25 can be fastened to the current conductor 11 shown in FIG. 1 while forming a press-in connection, as can be seen in the perspective view in accordance with FIG. 2a and in the sectioned view with respect to the current conductor 11 in accordance with FIG. 2b. The connector element 25 includes a plate-like contact portion 27 whose two narrow sides are pressed into the plug openings of the current conductor 11 formed in the recess 13 to effect a fastening of the connector element 25 at the current conductor 11.

The connector element 25 furthermore includes a spigot 29 which is plugged through the contact opening 23 of the current conductor 11 in the recess base 17 in a shape matched manner or with oversize with respect to the contact opening 23 while forming a press-in connection to create an electrical contact between the connector element 25 and the current conductor 11.

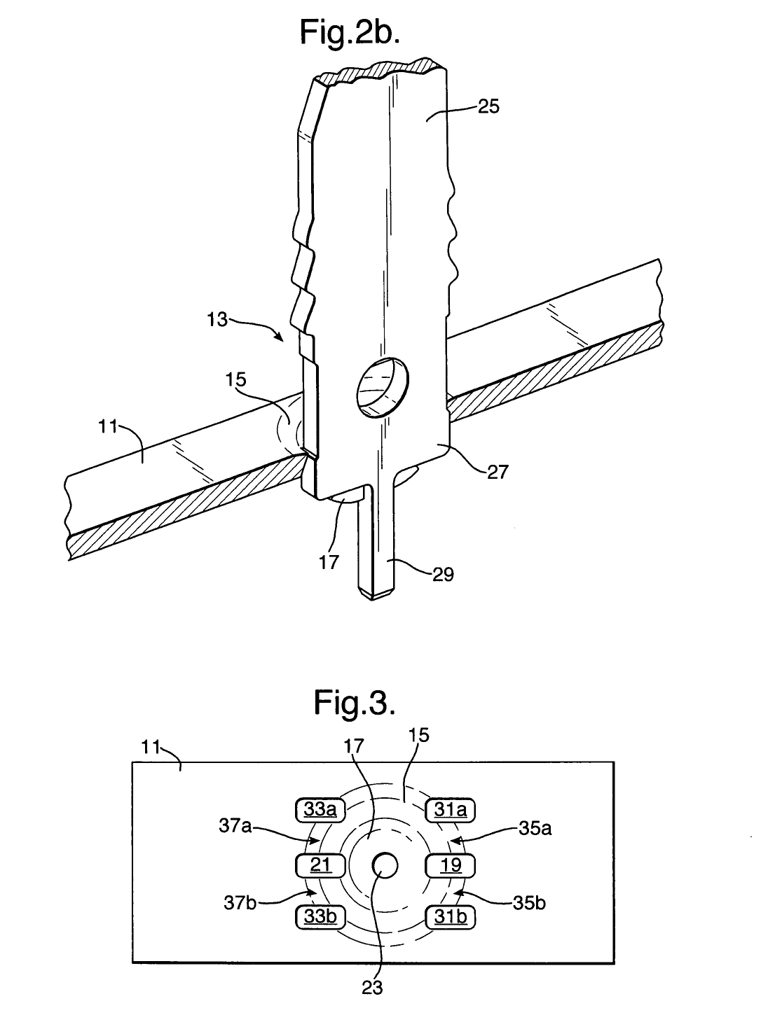

The current conductor 11 in accordance with a further aspect shown in a plan view in FIG. 3 has a respective adjacent further opening 31a, 31b on both sides of the plug opening 19 with respect to its longitudinal extent, said openings each piercing the current conductor 11. The further openings 31a and 31b are positioned such that a respective web portion 35a, 35b is formed between the plug opening 19 and the laterally arranged further openings 31a and 31b. The web portions 35a and 35b each act as bending beams in this respect which can escape in the direction of the further openings 31a, 31b to facilitate the pressing in on the pressing in of a connector element which has oversize with respect to the plug opening 19. In an analogous manner, adjacent further openings 33a and 33b for the plug opening 21 as well as associated web portions 37a, 37b are provided. The further openings 31a, 31b, 33a, 33b are each manufactured by stamping out.

The recess is formed first in the manufacture of the current conductor in accordance with the invention. Then the plug openings 19, 21, the contact opening 23 and the further openings 31a, 31b, 33a, 33b are stamped out, preferably simultaneously. Basically, however, stamping out can also be carried out first and then the deep drawing.

Overall, a particularly secure fastening for an electrically conductive connector element results with the current conductor in accordance with the invention.

1. A current conductor, to which at least one electrically conductive connector element can be fastened to form an electrical contact, wherein the current conductor has a recess that includes a wall section that is pierced by at least one plug opening for the connector element.

2. An apparatus in accordance with claim 1, wherein two plug openings each piercing the wall section are provided.

3. An apparatus in accordance with claim 2, wherein the plug openings are oppositely disposed with respect to a central axis of the recess.

4. An apparatus in accordance with at claim 1, wherein at least one adjacent opening is provided for the plug opening, said adjacent opening piercing the current conductor, and wherein the adjacent opening is positioned such that a web portion is formed that is arranged in the region of the wall section.

5. An apparatus in accordance with at claim 1, wherein the recess is pot-shaped.

6. An apparatus in accordance with claim 1, wherein the recess includes a recess base that is pierced by a contact opening into which a spigot of the connector element can be plugged or pressed to form an electrical contact.

7. An arrangement comprising at least one current conductor in accordance with claim 1, to which at least one electrically conducting connector element is fastened to form an electrical contact, said connector element including a contact section that is pressed into the at least one plug opening of the current conductor.

8. An arrangement in accordance with claim 7, wherein the connector element includes a spigot that is plugged or pressed into a contact opening of the current conductor piercing a recess base of the recess to form an electrical contact.

9. A method of manufacturing a current conductor, to which at least one electrically conductive connector element can be fastened to form an electrical contact,
wherein:
a region of the current conductor is selected for the fastening of the connector element;
in that the region is worked, in particular by deep drawing, such that a recess is formed; and
in that a marginal section or wall section of the region is worked, in particular by stamping out, such that at least one plug opening is formed;
wherein a contact section of the connector element is able to be pressed into the at least one plug opening.

10. A method in accordance with claim 9, wherein first the recess is made and then the plug opening, or vice versa.

11. An apparatus in accordance with at claim 1, wherein at least one adjacent opening is provided for the plug opening, said adjacent opening piercing the current conductor, and wherein the adjacent opening is positioned such that a web portion acts as a bending beam between the plug opening and the adjacent opening.

12. An apparatus in accordance with at claim 1, wherein the recess is tub-shaped.

13. An apparatus in accordance with at claim 1, wherein the recess is rotationally symmetrical with respect to a central axis.

14. An apparatus in accordance with at claim 1, wherein the recess is pot-shaped and is rotationally symmetrical with respect to a central axis.
